(19) United States
(12) Patent Application Publication
(10) Pub. No.: US 2025/0046780 A1
(43) Pub. Date: Feb. 6, 2025

(54) FILM FORMATION APPARATUS AND METHOD FOR POWDERS, AND A METHOD OF MANUFACTURING A FILM USING THE SAME

(71) Applicants: HYUNDAI MOTOR COMPANY, Seoul (KR); KIA CORPORATION, Seoul (KR)

(72) Inventors: Hyun Jin Kim, Daegu (KR); Han Nah Song, Suwon-si (KR)

(73) Assignees: HYUNDAI MOTOR COMPANY, Seoul (KR); KIA CORPORATION, Seoul (KR)

(21) Appl. No.: 18/535,200

(22) Filed: Dec. 11, 2023

(30) Foreign Application Priority Data
Jul. 31, 2023 (KR) 10-2023-0099368

(51) Int. Cl. H01M 4/04; H01M 4/36

(52) U.S. Cl. CPC H01M 4/0435; H01M 4/0419; H01M 4/364

(57) ABSTRACT

Disclosed is a film formation improvement apparatus for powders, more particularly, a film formation improvement apparatus for dry electrode mixtures. An apparatus for manufacturing a film includes a roll press configured to apply pressure to supplied powder to be formed into a film, and the film formation improvement apparatus configured to induce a flow of the powder fed into a feeding zone of the roll press in a predefined direction.

### CROSS-REFERENCE TO RELATED APPLICATION

This application claims under 35 U.S.C. § 119 (a) the benefit of and priority to Korean Patent Application No. 10-2023-0099368, filed on Jul. 31, 2023, the entire contents of which are incorporated herein by reference.

### TECHNICAL FIELD

The present disclosure relates to a film formation improvement apparatus for powders. More particularly, it relates to a film formation improvement apparatus for dry electrode mixtures for batteries.

### BACKGROUND

Recently, application of rechargeable secondary batteries is extended to various fields from small electronic devices to large energy storage systems. Particularly, research and development of secondary batteries due to rapid growth of the electric vehicle market are being actively conducted.

Electrodes for secondary batteries are generally manufactured by a wet process. In the wet process, a slurry is manufactured by dissolving an electrode active material, a binder, and a conductive material, which are included in an electrode, in a solvent. However, in order to increase the energy density of a battery compared to the wet process, a dry process that does not use the solvent required in the wet process has recently been introduced.

In the dry process of an electrode, a mixture is prepared by mixing an electrode active material, a conductive material, and a binder. And then a dry electrode film is formed by performing a series of film forming processes by pressing or calendaring. Subsequently, manufacture of the electrode is completed by bonding the formed dry electrode film to a current collector.

Compared to the wet electrode manufacturing process, the dry electrode manufacturing process does not require a solvent and may thus reduce a manufacturing time and cost. Also, a dry electrode film having high energy density may be acquired as the thickness of the film can be controlled.

However, it is difficult to form the film at a high speed to achieve mass production of dry electrodes due to characteristics of the dry electrode mixture in a powdery state.

The above information disclosed in this Background section is only for enhancement of understanding of the background of the present disclosure and therefore it may contain information that does not form the prior art that is already known to a person of ordinary skill in the art.

### SUMMARY

The present disclosure has been made in an effort to solve the above-described problems associated with the prior art, and it is an object of the present disclosure to provide a film formation improvement apparatus for powders, which may form a film at a high speed while securing quality of an acquired film product.

In one aspect, the present disclosure provides an apparatus for manufacturing a film, including a roll press configured to apply pressure to supplied powder to be formed into the film. The present disclosure further provides a film formation improvement apparatus configured to induce a flow of the powder fed into a feeding zone of the roll press.

In another aspect, the present disclosure provides a method of manufacturing a film, including feeding powder, configured to be formed into the film, into a feeding zone of a roll press, and rotating the roll press and blade located in the feeding zone while providing pressing force to the roll press.

Other aspects and embodiments of the present disclosure are further discussed below.

The above and other features of the present disclosure are further discussed below.

### BRIEF DESCRIPTION OF THE DRAWINGS

The above and other features of the present disclosure are now described in detail with reference to certain exemplary embodiments thereof illustrated in the accompanying drawings which are given hereinbelow by way of illustration only, and thus are not limitative of the present disclosure, and wherein:

FIG. 1 is a view showing an exemplary process of manufacturing a dry electrode film in one embodiment of the present disclosure;

FIG. 2 is a view showing a feeding zone of an upstream roll press in one embodiment of the present disclosure;

FIG. 3A is a cross-sectional view of the feeding zone of FIG. 2, taken in the z-axis direction;

FIG. 3B is a cross-sectional view showing an angle of repose of a dry electrode mixture shown in FIG. 3A;

FIGS. 3C and 3D are cross-sectional views showing behavior of the dry electrode mixture by the angle of repose shown in FIG. 3B;

FIG. 4 is a view showing a film formation improvement apparatus disposed around the roll press according to one embodiment of the present disclosure;

FIG. 5 is a simplified cross-sectional view of FIG. 4, taken in the z-axis direction;

FIG. 6 is a view conceptually illustrating operation of a blade in the feeding zone shown in FIG. 4;

FIG. 7 is a view showing the film formation improvement apparatus according to one embodiment of the present disclosure;

FIGS. 8A, 8B and 8C are views showing positions of blades in the film formation improvement apparatus according to some embodiments of the present disclosure;

FIG. 9 is a plan view of the film formation improvement apparatus including a guide according to one embodiment of the present disclosure;

FIG. 10 is a view illustrating relations between the guide and the roll press in one embodiment of the present disclosure;

FIG. 11 is a view illustrating setup of the height of the blades of the film formation improvement apparatus according to one embodiment of the present disclosure;

FIG. 12 is a view illustrating the size or diameter of the blades of the film formation improvement apparatus according to one embodiment of the present disclosure; and

FIG. 13 is a cross-sectional view of the film formation improvement apparatus taken in the z-axis direction according to one embodiment of the present disclosure.

It should be understood that the appended drawings are not necessarily to scale, presenting a somewhat simplified representation of various features illustrative of the basic principles of the present disclosure. The specific design features of the present disclosure as disclosed herein, including, for example, specific dimensions, orientations, locations, and shapes, should be determined in part by the particular intended application and use environment.

In the figures, reference numbers refer to the same or equivalent parts of the present disclosure throughout the several figures of the drawing.

### DETAILED DESCRIPTION

Specific structural or functional descriptions in embodiments of the present disclosure set forth in the description which follows are exemplarily given to describe the embodiments of the present disclosure, and the present disclosure may be embodied in many alternative forms. Further, it should be understood that the present disclosure should not be construed as being limited to the embodiments set forth herein, and the embodiments of the present disclosure are provided to cover modifications, equivalents or alternatives which come within the scope and technical range of the present disclosure.

In the following description of the embodiments, terms, such as “first” and “second”, are used only to describe various elements, and these elements should not be construed as being limited by these terms. These terms are used only to distinguish one element from other elements. For example, a first element described hereinafter may be termed a second element, and similarly, a second element described hereinafter may be termed a first element, without departing from the scope of the present disclosure.

When an element or layer is referred to as being “connected to” or “coupled to” another element or layer, it may be directly connected or coupled to the other element or layer, or intervening elements or layers may be present. In contrast, when an element or layer is referred to as being “directly connected to” or “directly coupled to” another element or layer, there may be no intervening elements or layers present. Other words used to describe relationships between elements should be interpreted in a like fashion, e.g., “between” versus “directly between,” “adjacent” versus “directly adjacent,” etc.

Wherever possible, the same reference numbers are used throughout the drawings to refer to the same or like parts. The terminology used herein is for the purpose of describing particular embodiments only and is not intended to be limiting. As used herein, singular forms may be intended to include plural forms as well, unless the context clearly indicates otherwise. The terms “comprises,” “comprising,” “including,” and “having” are inclusive and therefore specify the presence of stated features, integers, operations, operations, elements, components, and/or combinations thereof, but do not preclude the presence or addition of one or more other features, integers, operations, operations, elements, components, and/or combinations thereof.

When a component, device, element, or the like of the present disclosure is described as having a purpose or performing an operation, function, or the like, the component, device, or element should be considered herein as being “configured to” meet that purpose or to perform that operation or function.

Hereinafter, reference is made in detail to various embodiments of the present disclosure, examples of which are illustrated in the accompanying drawings and described below.

A dry electrode may be manufactured from a dry electrode mixture M and a current collector without a solvent. The dry electrode mixture M is a mixture including an electrode active material, a conductive material, and a binder. The dry electrode may be a cathode or an anode. In some examples of implementation, when a cathode is manufactured, the electrode active material includes a cathode active material. As a non-limiting example, the cathode active material may include a lithium nickel manganese cobalt oxide (NMC), lithium ferrophosphate (LFP), lithium cobalt oxide (LCO), or sulfur. In some examples of implementation, when an anode is manufactured, the electrode active material includes an anode active material. For example, the cathode active material may be a layered compound, such as lithium cobalt oxide (LiCoO₂) or lithium nickel oxide (LiNiO₂) or a compound in which a part of the layered compound is substituted with one or more transition metals, a lithium manganese compound represented by a chemical formula of Li₁₊ₓMn₂₋ₓO₄ (x=1 to 0.33) such as LiMnO₃, LiMn₂O₃, or LiMnO₂, a lithium copper oxide such as Li₂CuO₂, a vanadium oxide such as LiV₃O₈, LiFe₃O₄, V₂O₅, or Cu₂V₂O₇, a Ni site-type lithium nickel oxide represented by a chemical formula of LiNi₁₋ₓMₓO₂ (M=Co, Mn, Al, Cu, Fe, Mg, B or Ga, and x=0.01 to 0.3), a lithium manganese composite oxide represented by a chemical formula of LiMn₂₋ₓMₓO₂ (M=Co, Ni, Fe, Cr, Zn or Ta, and x=0.01 to 0.1) or a chemical formula of Li₂Mn₃MO₈ (M=Fe, Co, Ni, Cu or Zn), LiMn₂O₄ in which a part of Li is substituted with an alkali earth metal ion, a lithium metal phosphate represented by a chemical formula of LiMPO₄ (M=Fe, Co, Ni or Mn), a disulfide compound, or Fe₂(MoO₄)₃, without being limited thereto.

As a non-limiting example, the anode active material may include graphite or silicon. For example, the anode active material may be carbon, such as hard carbon or graphitic carbon, a metal composite oxide such as LiₓFe₂O₃ (0≤x≤1), LiₓWO₂ (0≤x≤1), or SnₓMe₁₋ₓMe′_{y}O_{z} (Me=Mn, Fe, Pb or Ge, Me′=Al, B, P, Si, an element of Group I, II or III in the periodic table, or a halogen element, 0<x≤1, 1≤y≤3, and 1≤z≤8), lithium metal, a lithium alloy, a silicon-based alloy, a tin-based alloy, a silicon-based oxide, such as SiO, SiO/C or SiO₂, a metal oxide, such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄ or Bi₂O₅, a conductive polymer such as polyacetylene, or a Li—Co—Ni-based material.

The conductive material may include a carbonaceous material. For example, the conductive material may include one of various carbonaceous materials, such as super P, Ketjen black, single-walled carbon nanotubes (SWCNTs), or multi-walled carbon nanotubes (MWCNTs). Further, a dry electrode mixture prepared to manufacture a dry electrode for all-solid-state batteries may further include a polyethylene oxide (PEO)-based polymer, an oxide-based solid electrolyte, and/or a sulfide-based solid electrolyte.

The binder may include a material having C—F bonds, i.e., including carbon and fluorine, such as polytetrafluoroethylene (PTFE) or polyvinylidene fluoride (PVDF). The binder may also include styrene butadiene rubber (SBR)/carboxy methyl cellulose (CMC) or polyacrylonitrile (PAN).

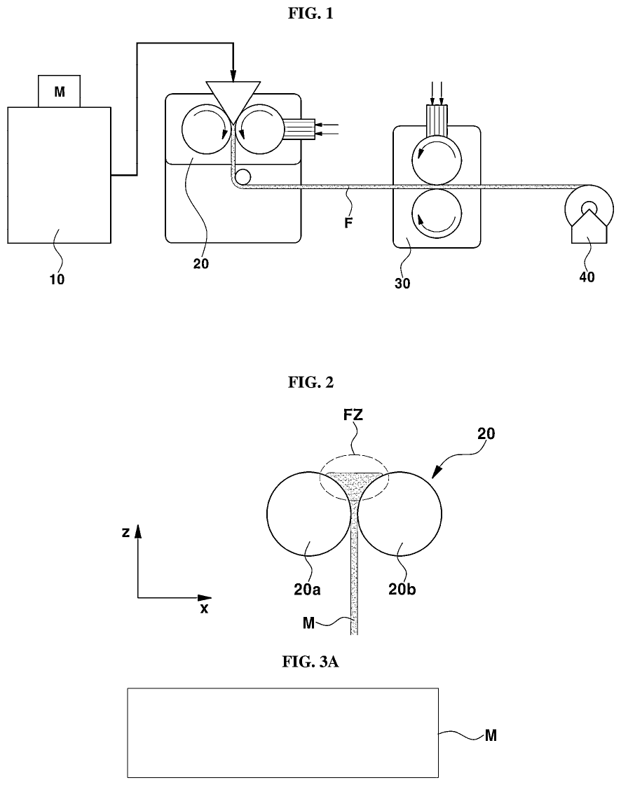

As shown in FIG. 1, the dry electrode mixture M is manufactured into a dry electrode film F through a series of film forming processes in which heat and pressure are applied. First, the dry electrode mixture M including the electrode active material, the conductive material, and the binder is mixed at a predetermined speed for a predetermined time by a mixer 10. As a non-limiting example, the dry electrode mixture may be manufactured through a high-shear mixer using rotation or a pneumatic mixer using air. The predetermined time and speed may be adjusted through changes in the rotational speed and the operating time of the mixer 10. As another non-limiting example, the dry electrode mixture may be manufactured using a compactor, a granulator, or a combination thereof.

The mixed dry electrode mixture M may be primarily pressed by an upstream roll press 20 to be formed into a dry electrode film F. The upstream roll press 20 is rotated while providing pressing force, thereby forming the dry electrode film F from the dry electrode mixture M. The dry electrode film F acquired by primarily pressing the dry electrode mixture M may be additionally pressed by a downstream roll press 30. The thickness of the dry electrode film F may be adjusted through such additional pressing. The dry electrode film F is wound by a winder 40. Thereafter, a dry electrode may be manufactured by bonding or laminating the dry electrode film F to or on the current collector. Formation of the dry electrode film F and lamination of the dry electrode film F on the current collector may be performed in a single apparatus or may be performed in respective apparatuses.

As shown in FIG. 2, the dry electrode mixture M stays in a feeding zone FZ, into which the dry electrode mixture M is fed, of the upstream roll press 20. As time elapses, the shape of the dry electrode mixture M staying in the feeding zone FZ has a specific pattern due to the angle of repose of the dry electrode mixture M. As rolls 20a and 20b of the upstream roll press 20 are rotated, the dry electrode mixture M piled in the feeding zone FZ is consumed while being formed into the dry electrode film F. The dry electrode mixture M is moved to an empty space formed due to consumption of the dry electrode mixture M. Such a flow forms the specific pattern caused by the angle of repose while collapsing the dry electrode mixture M piled up flat in the feeding zone FZ. In FIG. 2, the x-axis direction refers to a horizontal direction, and the z-axis direction refers to a vertical direction.

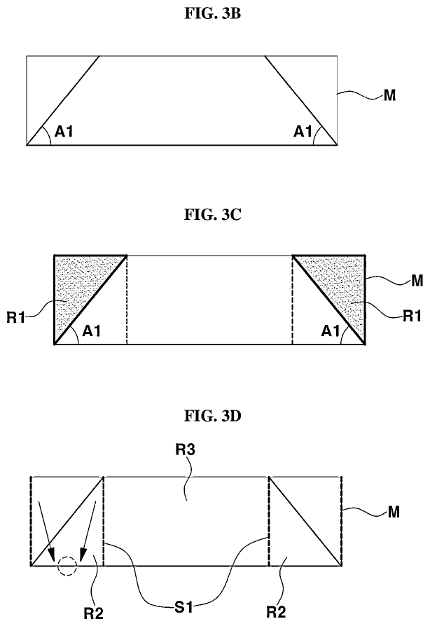

FIGS. 3A, 3B, 3C and 3D are cross-sectional views of the dry electrode mixture M in the feeding zone FZ, taken in the z-axis direction. A region R1 refers to an end region of the feeding zone FZ, which is located at an angle greater than the angle of repose A1 of the dry electrode mixture M. A funnel flow region R2 is a region in which the dry electrode mixture M partially flows and indicates a region in which the dry electrode mixture M coming into contact with the region R1 does not flow and only the dry electrode mixture M located at the center flows. A mass flow region R3 indicates a region in which the entirety of the dry electrode mixture M flows.

FIG. 3A shows the dry electrode mixture M piled to a designated height in the feeding zone FZ. The dry electrode mixture M in a powdery form has the angle of repose A1 in the feeding zone FZ (with reference to FIG. 3B). The angle of repose A1 is one unique characteristic of powder and refers to the steepest angle at which the powder can be piled on an inclined plane without slumping.

Here, as shown in FIG. 3C, the dry electrode mixture M located in the region R1 provided at the angle greater than the angle of repose A1 is in an unstable state. In order to be freed from the unstable state of the dry electrode mixture M in the region R1, the dry electrode mixture M located in the funnel flow region R2 under the region R1 rapidly flows. In other words, the dry electrode mixture S piled between the rolls 20a and 20b of the upstream roll press 20 exhibits characteristics of the angle of repose A1, and the flow of the dry electrode mixture M is concentrated upon a specific part thereof.

In order to recover from the unstable state of the dry electrode mixture M in the region R1 caused by the characteristics of the angle of repose A1, the dry electrode mixture M should rapidly flow. However, a plane S1 (i.e., a vertical plane facing the angle of repose A1) functions as a wall against the flow of powder, i.e., the dry electrode mixture M, as shown in FIG. 3D. The plane S1, which is the interface between the mass flow region R3 and the funnel flow region R2, acts as the wall against the flow of the dry electrode mixture M in the powdery state.

The dry electrode mixture M is smoothly fed into the upstream roll press 20 without any congestion in the mass flow region R3 in which the entirety of the dry electrode mixture M flows. However, the powder, i.e., the dry electrode mixture M, is concentrated upon a specific location in the funnel flow region R2 in which the dry electrode mixture M trapped by the plane S1 flows. Such a concentration causes a larger amount of the dry electrode mixture M in this part than in other parts to be fed between the rolls 20a and 20b of the upstream roll press 20, and thus, a larger amount of the powder, i.e., the dry electrode mixture M, is consumed in this part.

A relatively large amount of the powder in this part is fed into the upstream roll press 20 and formed into the dry electrode film F, which causes the manufactured dry electrode film F to have an uneven thickness. The dry electrode film F having an uneven thickness may be torn when the film forming processes are performed at a high speed. Since both sides of the dry electrode films F are used in a following lamination process, such a thickness variation may pose a serious effect.

Therefore, the present disclosure aims to provide a film formation improvement apparatus 100 for powders, which may form a film at a high speed while securing quality of a manufactured dry electrode mixture. The film formation improvement apparatus 100 may prevent concentration of powder, i.e., the dry electrode mixture M, on a specific part of the funnel flow region R2 by inducing the flow of the dry electrode mixture M fed into the funnel flow region R2.

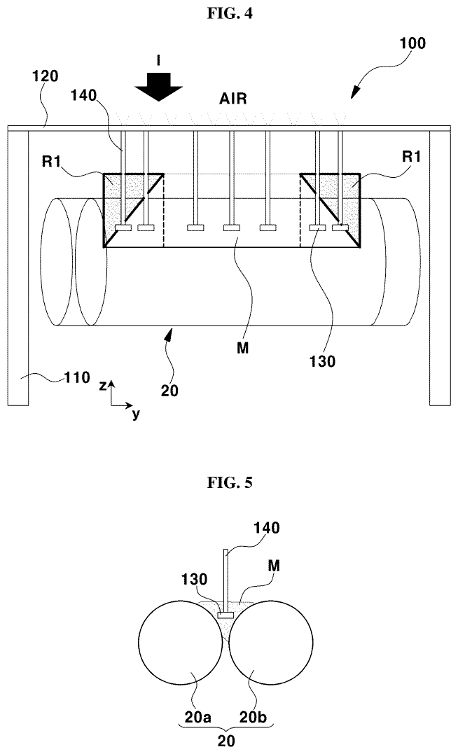

Referring to FIGS. 4-7, according to the present disclosure, the film formation improvement apparatus 100 is disposed around the upstream roll press 20. The film formation improvement apparatus 100 may be supported by a frame 110 around the upstream roll press 20. The frame 110 includes an extension rod 120 which extends in a longitudinal direction, i.e., the y-axis direction of the rolls 20a and 20b.

Blades 130 are suspended from the extension rod 120. For example, the blades 130 may be suspended from the extension rod 120 by vertical rods 140. The blades 130 may be detachably attached to the vertical rods 140.

The blades 130 are configured to be rotatable. As the rotatable vertical rods 140 are rotated, the blades 130 connected to the vertical rods 140 may be also rotated. The vertical rods 140 may be rotated by rotary gears 150 rotatably disposed in the extension rod 120. As a non-limiting example, the blades 130 may be a propeller type, a paddle type, an anchor type, a gate type, a ribbon type, a screw type, a turbine type, a disk type, or Brumagin type.

A motor 160 is disposed in the extension rod 120. The rotary gears 150 are mounted on a rotary shaft 170 of the motor 160. Rotation of the rotary gears 150 may be transmitted to the vertical rods 140. As a non-limiting example, motion may be transmitted between the vertical rods 140 and the extension rod 120 by engagement as in a bevel gear.

Further, the film formation improvement apparatus 100 may include a power supply 182 configured to provide a driving force to the motor 160 and a controller 180 configured to adjust the rotational speed of the motor 160. As a non-limiting example, the power supply 182 and the controller 180 may be provided in the frame 110.

The controller 180 may control the motor 160 so that the blades 130 are driven by a driving value of the upstream roll press 20. For example, the rolls 20a and 20b and the blades 130 may be configured to be rotated at the same speed. On the other hand, the blades 130 may be configured to be rotated at a higher speed than the rolls 20a and 20b. When the dry electrode mixture M partially includes a solid electrolyte or the dry electrode mixture M in the powdery state clumps severely, clumping may be reduced or prevented by rotating the blades 130 at a higher speed than the rolls 20a and 20b. As one example, the rotational speed of the blades 130 may be several tens of to thousands of RPM.

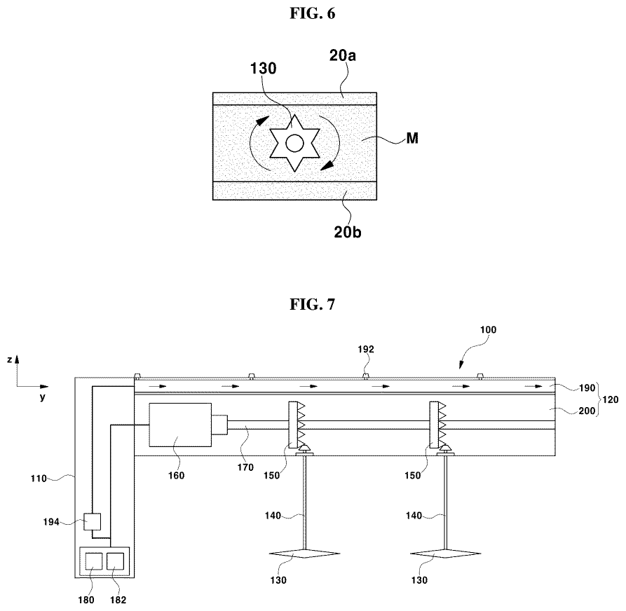

As shown in FIGS. 5 and 6, the blades 130 are configured to be rotatable in the feeding zone FZ. The positions of the blades 130 in the feeding zone FZ may be adjusted and set.

In some embodiments, the positions of the blades 130 in the longitudinal direction of the rolls 20a and 20b of the upstream roll press 20 (i.e., in the y-axis direction) may be set. The positions of the blades 130 in the longitudinal direction of the rolls 20a and 20b depend on the width of the dry electrode film F manufactured by the upstream roll press 20 and the height of the feeding zone FZ varied depending on the feeding amount of the dry electrode mixture M.

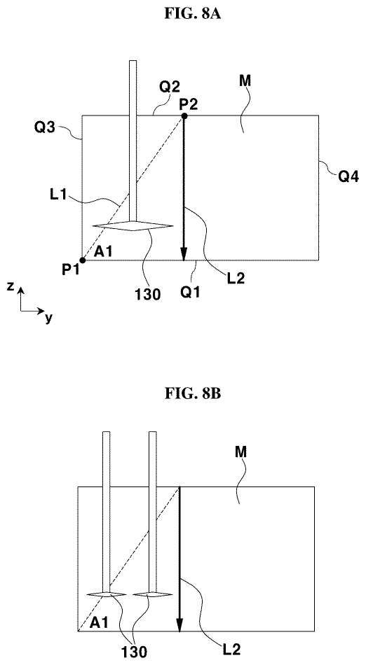

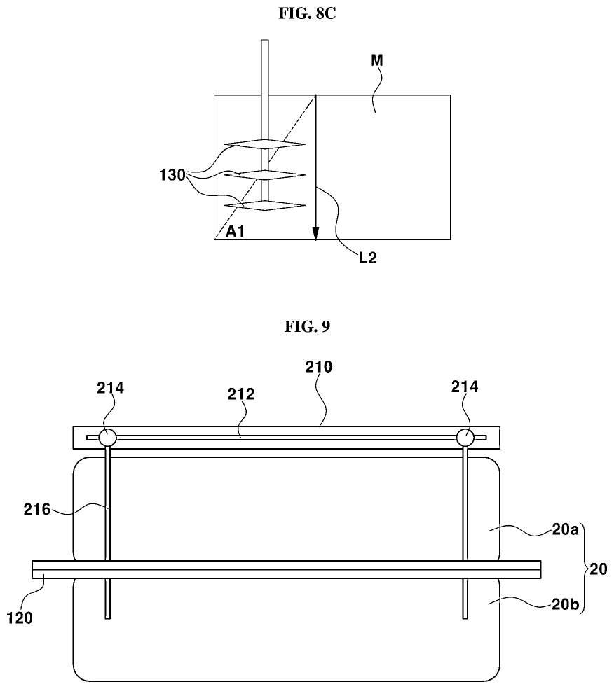

In one embodiment, the dry electrode mixture M piled in the feeding zone FZ may be formed by six planes (for example, may have a pyramidal shape). However, the dry electrode mixture M piled in the feeding zone FZ may be expressed by four planes Q1, Q2, Q3 and Q4 in the cross-sectional view of the feeding zone Z, taken in the longitudinal direction, as shown in FIG. 8A.

The plane Q1 indicates a bottom surface of the dry electrode mixture M piled in the feeding zone Z, and the plane Q2 indicates an upper surface of the dry electrode mixture M piled in the feeding zone Z. The planes Q3 and Q4 indicate end surfaces of the dry electrode mixture M piled in the feeding zone FZ in the longitudinal direction (i.e., in the y-axis direction).

An inclined plane L1 having the angle of repose A is drawn from a point P1, at which the plane Q1 and the plane A3 meet each other and extends to the plane Q2. Assuming that a point, at which the inclined plane L1 and the plane Q2 meet each other, is referred to as P2, a vertical plane L2 which vertically connects the point P2 to the plane Q1 may be acquired. The vertical plane L2 faces the angle of repose A1. According to the present disclosure, the blades 130 may be disposed in a space defined by the vertical plane L2, the inclined plane L1, and the plane Q1.

In some embodiments, as shown in FIG. 8B, one or more blades 130 may be disposed depending on the diameter or size of the blades 130. In another embodiment, one or more blades 130 may be disposed on one vertical rod 140 when the height of the dry electrode mixture M is high. In some examples, when a plurality of blades 130 is disposed, the sizes of the respective blades 130 may be the same or be different.

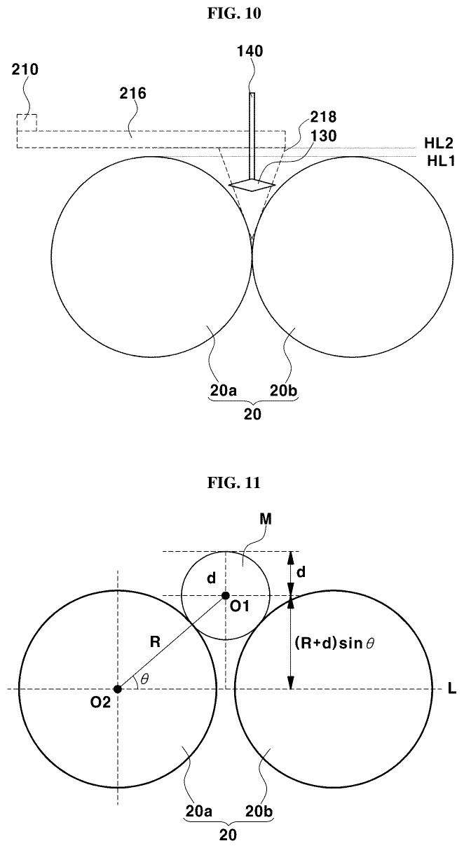

Referring to FIGS. 9 and 10, according to an embodiment of the present disclosure, a guide 210 may be disposed around the film formation improvement apparatus 100. The guide 210 may be disposed in parallel with the rolls 20a and 20b. Rollers 214 configured to be movable along a rail 212 of the guide 210 are disposed on the rail 212. Horizontal rods 216 configured to extend toward the feeding zone FZ are disposed on the rollers 214. Guide members 218 configured to adjust the width of the dry electrode mixture M fed between the rolls 20a and 20b are disposed on the horizontal rods 216. Therefore, the positions of the guide members 218 in the longitudinal direction of the rail 212 may be changed by movement of the rollers 214 along the rail 212, and may thus adjust the width of the dry electrode mixture M which will be formed into the dry electrode film F.

The height of the blades 130 and the diameter or size of the blades 130 in the feeding zone FZ may be set.

In one embodiment, the height or the position in the vertical direction (i.e., in the z-axis direction) of the blades 130 may be determined depending on a gap between the rolls 20a and 20b and presence of the guide 210. Regardless of whether the guide 210 is present, the blades 130 may be disposed at a position between the rolls 20a and 20b, which does not interfere with the rolls 20a and 20b. However, when the guide 210 is present, the height of the dry electrode mixture M in the feeding zone FZ is increased compared to the case where the guide members 218 are not provided, and thus, the height of the blades 130 may be determined as a position in the vertical direction which does not interfere with the guide members 218. Referring again to FIG. 10, theoretically, the feeding zone FZ may be formed by piling the dry electrode mixture M up to a horizontal line HL1 between the rolls 20a and 20b, when no guide 210 is present, and may be formed by piling the dry electrode mixture M to a horizontal line HL2, when the guide 210 is present. Therefore, in the former case, the blades 130 having a diameter, which does not interfere with the rolls 20a and 20b, may be disposed at any position in the vertical direction. In the latter case, the blades 130 may be disposed at a position in the vertical direction, which does not interfere with the roll 20a and 20b and the guide 210.

In summary, the blades 130 are disposed above a point at which film formation from the dry electrode mixture M by the rolls 20a and 20b is started and may be disposed below the uppermost end of the dry electrode mixture M piled in the feeding zone FZ. As described herein, the point at which film formation from the dry electrode mixture M is started may be expressed as a region in which the gap between the rolls 20a and 20b is smallest.

Referring to FIG. 11, the minimum height of the blades 130 may be determined based on a distance from the center O1 of the dry electrode mixture M in the feeding zone FZ to the center O2 of one of the rolls 20a and 20b, an angle θ between a line R+d connecting the center O1 of the dry electrode mixture M to the center O2 of the one of the rolls 20a and 20b and a horizontal line L passing through the center O2 of one of the rolls 20a and 20b, and a radius d of the dry electrode mixture M. Here, a region in which the horizontal line L meets the gap between the rolls 20a and 20b may be referred to as the point at which film formation from the dry electrode mixture M by the rolls 20a and 20b is started, as seen in the vertical direction (i.e., in the z-axis direction). Further, the radius d of the dry electrode mixture M means the radius of one cluster formed by agglomeration of particles of the dry electrode mixture M due to fibrillization of the binder.

In one embodiment, the minimum height of the blades 130 may be set to a value greater than (R+d) sin θ+d. Here, R is a radius of the rolls 20a and 20b. The minimum height of the blades 130 in the feeding zone FZ is calculated so that the blades 130 almost touch the rolls 20a and 20b. In other words, the minimum height of the blades 130 may indicate the minimum height of the blades from the point of the upstream roll press 20 or the position thereof in the vertical direction, at which film formation is started.

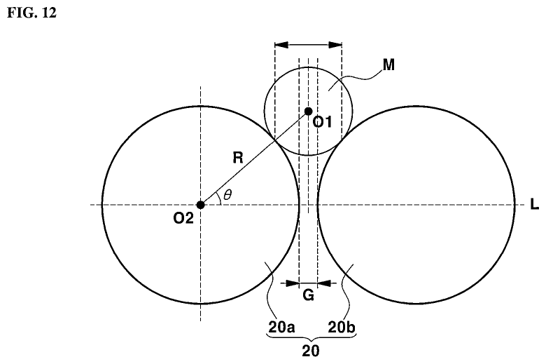

The diameter or size of the blades 130 may be determined in consideration of the gap between the rolls 20a and 20b and the size of the particles of the dry electrode mixture M. The reason for this is that, when the blades 130 are disposed between the rolls 20a and 20b, a space for the dry electrode mixture M to flow between the blades 130 and the rolls 20a and 20b is required. Referring to FIG. 12, the maximum diameter or size of the blades 130 may be determined based on the radius R of the rolls 20a and 20b, the gap G between the rolls 20a and 20b, and the angle θ between the line connecting the center O1 of the dry electrode mixture M to the center O2 of one of the rolls 20a and 20b and the horizontal line L passing through the center O2 of the one of the rolls 20a and 20b. In one embodiment, the diameter of the blades 130 may be selected as a value less than 2R+G−2R cos θ. The maximum diameter of the blades 130 may indicate the maximum diameter of the blades 130 when the blades are disposed at which film formation starts in the upstream roll press 20 or are in a vertical position with respect to the roll press 20.

The angle θ, a so-called nip angle, is defined based on one particle. However, in the case of the dry electrode mixture M, the mixture of the electrode active material, the conductive material and the binder is present in the form of clusters. Thereby, in the dry electrode mixture M, the nip angle θ is defined based on one cluster rather than one particle. Therefore, the minimum value of the height of the blades 130 and the maximum value of the size of the blades 130 may be theoretically calculated.

According to some embodiments, the film formation improvement apparatus 100 may include a gas supply line 190. Gas nozzles 192 may be mounted on the extension rod 120. A gas supplied through the gas supply line 190 may be sprayed through the gas nozzles 192. The gas may be supplied to the gas supply line 190 by a gas supply source 194, such as a gas tank, provided in the frame 110 or at the outside of the film formation improvement apparatus 100. The sprayed gas may prevent the dry electrode mixture M from being piled on the frame 110 of the film formation improvement apparatus 100, caused by partial interference of the film formation improvement apparatus 100 with the dry electrode mixture M in a direction of feeding the dry electrode mixture M between the rolls 20a and 20b of the upstream roll press 20. Therefore, the sprayed gas may be sprayed in a direction opposite to the flow of the dry electrode mixture M.

Operation of the gas nozzles 192 may be controlled by the controller 180. For example, the gas nozzles 192 may spray gas at intervals of 1 minute or less by instructions from the controller 80 and may spray the gas for 30 seconds or less when spraying once. However, these values are not fixed and may be changed depending on the characteristics of the dry electrode mixture M or powder in the feeding zone FZ. As a non-limiting example, the pressure of the sprayed gas may be 0.1 to 50 bar.

In one embodiments, the gas supplied through the gas supply line 190 may be compressed air. In other embodiment, the gas supplied through the gas supply line 190 may be unreactive gas or inert gas, such as argon. For example, when the electrode active material of the dry electrode mixture M includes a solid electrolyte or an additive having high reactivity, unreactive gas or inert gas may be used.

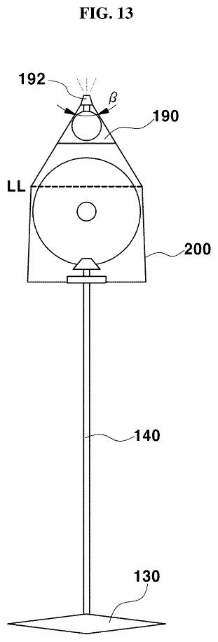

As shown in FIG. 13, the gas supply line 190 and a blade drive unit 200 are physically separated from each other in the frame 110. The upper end of the film formation improvement apparatus 100 facing a line LL may be designed to have an angle β which is a value obtained by adding about 5 degrees or more to the angle of repose A1 of the dry electrode mixture M used in the film forming processes so that the dry electrode mixture M may slip better. For example, the angle may be at least 40 degrees. The reason for this is that the dry electrode mixture M supplied from the upper end of the film formation improvement apparatus 100 slides toward the upstream roll press 20 without being piling in the film formation improvement apparatus 100.

The operation and effects of the film formation improvement apparatus 100 according to the present disclosure are as follows.

The dry electrode mixture M is piled in the feeding zone FZ of the upstream roll press 20 while being fed into the upstream roll press 20.

As the film formation improvement apparatus 100 provided in the feeding zone FZ is operated, the upstream roll press 20 is operated. In one embodiment, the blades 130 are operated at a predetermined speed. Therefore, the film formation improvement apparatus 100 may prevent the dry electrode mixture M from being concentrated on a specific position in the feeding zone FZ by inducing the flow of the dry electrode mixture M.

Since the dry electrode mixture M is supplied in a flow direction I from above the film formation improvement apparatus 100, the film formation improvement apparatus 100 may partially interfere with the flow of the fed dry electrode mixture M. Therefore, the film formation improvement apparatus 100 may intermittently or continuously spray gas through the gas nozzles 192 of the gas supply line 190.

The film formation improvement apparatus 100 may improve concentration of the dry electrode mixture M on the specific position and may allow the evenly distributed amount of the dry electrode mixture M to be supplied to all sections between the rolls 20a and 20b, thereby being capable of completing formation of the dry electrode film F having uniform quality.

Although the above description illustrates that the film formation improvement apparatus 100 is used in the film forming processes of the dry electrode mixture for batteries, the film formation improvement apparatus 100 according to the present disclosure may be applied to the film forming processes of other powders as well as the film forming processes of the dry electrode mixture.

As is apparent from the above description, the present disclosure provides a film formation improving apparatus for powders, which may form a film at a high speed while securing quality of an acquired film product.

The present disclosure has been described in detail with reference to some embodiments thereof. However, it should be appreciated by those having ordinary skill in the art that changes may be made in these embodiments without departing from the principles and spirit of the present disclosure, the scope of which is defined in the appended claims and their equivalents.

What is claimed is:

1. An apparatus for manufacturing a film, comprising:
a roll press configured to apply a pressure to supplied powder and form the powder into the film; and
a film formation apparatus configured to induce in a preset direction a flow of the powder fed into a feeding zone of the roll press.

2. The apparatus of claim 1, wherein the film formation apparatus comprises:
a frame; and
a rotatable blade connected to the frame and disposed in the feeding zone.

3. The apparatus of claim 2, wherein the film formation apparatus further comprises a motor configured to provide a rotational force to the rotatable blade.

4. The apparatus of claim 3, further comprising a controller configured to control a rotational speed of the motor.

5. The apparatus of claim 2, wherein the film formation apparatus further comprises;
a gas supply line provided in the frame; and
a gas nozzle provided on the gas supply line and configured to spray air to remove the powder piled on the frame.

6. The apparatus of claim 2, further comprising a guide disposed in the feeding zone and configured to be movable along the roll press to adjust a width of the fed powder.

7. The apparatus of claim 6, wherein the guide comprises:
a roller configured to be movable along a rail of the guide;
a horizontal rod connected to the roller; and
a guide member connected to the horizontal rod and configured to be movable with respect to the feeding zone.

8. The apparatus of claim 2, wherein the rotatable blade is disposed in a predetermined region of the feeding zone, wherein the predetermined region is formed in a longitudinal end part of the feeding zone.

9. The apparatus of claim 8, wherein the predetermined region is defined by:
a bottom surface of the powder fed into the feeding zone;
an inclined plane connecting a first point where the bottom surface and a longitudinal end surface of the powder meet each other to an upper surface of the powder at an angle of repose of the powder; and
a vertical plane configured to vertically connect a second point where the inclined plane is connected to the upper surface of the powder to the bottom surface of the powder.

10. The apparatus of claim 2, wherein a height of the rotatable blade from the roll press in the feeding zone is determined based on a gap between rolls in the roll press.

11. The apparatus of claim 2, wherein a diameter of the rotatable blade in the feeding zone is determined based on a gap between rolls of the roll press and a size of a particle of the powder.

12. The apparatus of claim 2, wherein a minimum height of the rotatable blade in the feeding zone is determined based on a distance from a center of the powder in the feeding zone to a center of one of rolls of the roll press, an angle (θ) between a line configured to connect the center of the powder to the center of the one of the rolls and a horizontal line configured to pass through the center of the one of the rolls, and a radius of the powder, and
wherein the minimum height of the rotatable blade is further determined from a position at which a gap between the rolls of the roll press is smallest.

13. The apparatus of claim 12, wherein the minimum height of the rotatable blade is set to a value greater than (R+d) sin θ+d,
wherein R is a radius of the rolls, and d is the radius of the powder.

14. The apparatus of claim 2, wherein a maximum diameter of the rotatable blade in the feeding zone is determined based on a radius of rolls of the roll press, a gap (G) between the rolls of the roll press, and an angle (θ) between a line connecting a center of the powder to a center of one of the rolls and a horizontal line configured to pass through the center of the one of the rolls, and
wherein the maximum diameter of the rotatable blade is an allowable radius at a position where the gap between the rolls is smallest.

15. The apparatus of claim 14, wherein the maximum diameter of the rotatable blade is set to a value less than 2R+G−2R cos θ,
wherein R is the radius of the rolls.

16. The apparatus of claim 6, wherein a height of the rotatable blade from the roll press in the feeding zone is determined based on a gap between rolls of the roll press and a height of the guide from the roll press.

17. The apparatus of claim 1, wherein the powder is a dry electrode mixture, wherein the dry electrode mixture is a mixture in a powdery form comprising an electrode active material, a conductive material, and a binder.

18. A method of manufacturing a film, comprising:
feeding powder configured to be formed into the film into a feeding zone of a roll press; and
rotating the roll press and a blade located in the feeding zone while providing a pressing force to the roll press.

19. The method of claim 18, wherein the roll press and the blade are rotated at a same speed, or the blade is rotated at a higher speed than a speed of rolls of the roll press.

20. The method of claim 18, wherein rotating of the roll press and the blade comprises spraying a gas toward a direction opposite to a flow of the powder by a gas supply line disposed around the feeding zone.

21. The method of claim 18, wherein the powder is a dry electrode mixture, wherein the dry electrode mixture is a mixture in a powdery form comprising an electrode active material, a conductive material, and a binder.
